(19) United States
(12) Patent Application Publication
(10) Pub. No.: US 2022/0282967 A1
(43) Pub. Date: Sep. 8, 2022

(54) METHOD AND MOBILE DETECTION UNIT FOR DETECTING ELEMENTS OF INFRASTRUCTURE OF AN UNDERGROUND LINE NETWORK

(71) Applicant: DEEPUP GMBH, Bonn (DE)

(72) Inventors: Michael Putz, Bonn (DE); Sinka Ismail, Bonn (DE); Marcus Opden Berg, Bonn (DE); Marco Arnold, Bonn (DE); Peter Rückrich, Bonn (DE)

(21) Appl. No.: 17/770,750

(22) PCT Filed: Oct. 27, 2020
(86) PCT No.: PCT/EP2020/080210

§ 371 Date: Apr. 21, 2022

(30) Foreign Application Priority Data
Oct. 28, 2019 (DE) 10 2019 216 548.6

(51) Int. Cl. G01C 7/06; G01C 15/00

(52) U.S. Cl. CPC G01C 7/06; G01C 15/002

(57) ABSTRACT

A method for the positionally correct capture of exposed infrastructure elements arranged underground, in an open excavation, by means of a mobile capture apparatus including: by a 3D reconstruction device, image data and/or depth data of a scene containing at least one exposed infrastructure element arranged underground are captured and a 3D point cloud having a plurality of points is generated on the basis of these image data and/or depth data; by of one or more receivers, signals of one or more global navigation satellite systems are received and a first position indication of the position of the capture apparatus in a global reference system is determined; and a plurality of second position indications of the position of the capture apparatus in a local reference system and a plurality of orientation indications of the orientation of the capture apparatus in the respective local reference system are determined.

### CROSS-REFERENCE TO RELATED APPLICATIONS

This application is a US National Stage Entry of PCT/EP/2020/080210 filed on Oct. 27, 2020, which claims priority to DE 10 2019 216 548.6 filed on Oct. 28, 2019.

### FIELD

The invention relates to a method for the positionally correct capture of exposed infrastructure elements arranged underground, in particular in an open excavation, by means of a mobile capture apparatus. Furthermore, the invention relates to a mobile capture apparatus for the positionally correct capture of exposed infrastructure elements arranged underground, in particular in an open excavation. The exposed infrastructure elements are, in particular, infrastructure elements of distribution networks.

### BACKGROUND

Underground infrastructure elements are usually situated in large numbers in so-called line networks. These line networks are differentiated as so-called transmission and distribution networks both in terms of their network structure and in terms of the manner in which they are laid and in terms of their regulatory boundary conditions. While transmission networks consist of superordinate, large, individual long-distance lines with rectilinear courses for national and international transport, the distribution networks, with their high degree of intermeshing of a plurality of infrastructure elements and their structure that is composed of small parts or is highly ramified, perform the regional redistribution to the end consumers. Infrastructure elements of the transmission networks are even laid significantly more deeply than those of distribution networks.

According to the specifications and regulations of the owners and operators of public distribution networks, for the documentation of line networks laid in the ground, nowadays a distinction is drawn between two measurement variants, in principle, across multiple sectors: the lines and connection elements are calibrated either by means of electronic tachymeter devices, GNSS systems (abbreviation of Global Navigation Satellite System) or even manually by means of the traditional tape measure. In the case of laying fiber-optic cables, for the purpose of later locating, so-called spherical markers with an RFID chip (abbreviation of radio-frequency identification) have recently been used as well, since calibration by the current conventional methods is inadequate with regard to accuracy. For the calibration of underground line networks, external firms of engineers for surveying are generally commissioned for construction projects. In this case, there is a high time expenditure on coordination between the customer (network operator), the contractor (construction company) and the sub-service provider (surveying engineer). At the same time the customer currently still does not acquire a georeferenced, three-dimensional model of the installed infrastructure elements which the customer could use e.g. for quality investigations regarding conformity to guidelines or for later line information. In the case of small construction projects such as e.g. the connection of an individual consumer to the distribution network, the construction companies often only prepare rough sketches by means of a tape measure on site for cost and time reasons. These sketches are in some instances very susceptible to errors and also inaccurate. In both measurement variants, the line as an infrastructure element is depicted in the documentation drawings generally only by a sequence of traverses. The actual geometric course of a line is thus disregarded here.

Both for the maintenance of these line networks and for the planning of new civil engineering projects in the vicinity of such line networks in the distribution network, it is accordingly absolutely necessary to have available documentation that is as precise as possible with accurate position indications of these underground infrastructure elements with an absolute accuracy of a few centimeters. Inadequate knowledge about these infrastructure elements in respect of location and depth may result in damage to these infrastructure elements, to interruptions of supply and in the worst case even to fatal injuries to persons.

US 2014 210 856 A1 describes a method for capturing and visualizing infrastructure elements of a line network which are arranged in a manner concealed in a wall or floor element of a building. In a state in which the infrastructure elements are arranged in an exposed manner, they are captured by means of a laser scanner. A control point, the coordinates of which are known, is additionally captured. On the basis of the data captured by the laser scanner, a 3D model of the infrastructure elements is created, the coordinates of which model are defined in relation to the control point. After the infrastructure elements have been concealed, a marker is arranged at a visible place. For the visualization of the now concealed infrastructure elements, said marker is captured by a camera of a mobile display unit and the 3D model of the infrastructure elements is represented in a manner superposed on the camera image in the display unit. What has proved to be disadvantageous about the known method, however, is that both during the capture of the infrastructure elements for the purpose of generating the 3D model and during the visualization of the 3D model superposed on the camera image in the captured scene, a respective control point or marker has to be arranged. This results in a relatively large number of work steps and also an increased susceptibility to vandalism, for example the undesired removal or displacement of the markers.

WO 2018/213 927 A1 describes a method for capturing exposed infrastructure elements of a large national long-distance line (“pipeline”) in a transmission network, which pursues the objective of checking the minimum depth of cover prescribed by regulations. For this purpose, a platform mounted on a vehicle outside the excavation is moved at constant speed in a forward direction along the exposed pipeline. A local point cloud is generated by means of a conventional LIDAR measuring apparatus connected to the mobile platform via a mechanical apparatus. In the local point cloud, a geometric feature, for example a longitudinal axis of a pipeline, is identified with the aid of an edge recognition algorithm. In a further step, the geometric feature can be linked with absolute position data obtained via a global navigation satellite system.

This system is designed for checking the laying depths—prescribed by regulations—of pipelines that are exposed for a relatively long period of time in rural areas, with comparatively large diameters of approximately 1 m and rectilinear, foreseeable courses. This method is not suitable, however, for the positionally correct capture of infrastructure elements of underground distribution networks such as, for example, fiber-optic cables having a small cross section and a ramified course, particularly in a town/city environment. This is because in view of traffic law orders relating to roads and the often limited available route area below ground level, the drainage systems of civil engineering projects in town/city and suburban distribution networks run with smaller parts than in pipeline construction and the excavations are typically between 0.3 and 2 m deep. In the case of such civil engineering projects, it is necessary to capture the infrastructure elements with an absolute accuracy in the range of a few centimeters. On account of the enormous deadline pressure to complete the construction project on schedule, during calibration the construction site employees typically carry out further work both outside and in the excavation. Furthermore, there is often no accessibility next to and above the excavation, for example owing to trees, parked automobiles or construction site materials, which means that the excavation has to be traversed in the meantime during calibration. The constantly variable ambient conditions thus make the capture of the infrastructure elements distinctly unpredictable. An additional factor is sensor-typical and external disturbance influences that have a very adverse impact on the relative accuracy of an inertial measurement unit (IMU) and also the absolute accuracy of the measurements of the global navigation satellite system on account of limited satellite visibility and poor mobile radio coverage. Furthermore, an inertial measurement unit is not designed to compensate sufficiently accurately for failures of the receiver for the global navigation satellite system. This means that in some regions and areas highly accurate satellite-based position determination is either not possible or possible only at points. Therefore, the mobile platform mounted on a vehicle, a robot or an unmanned aerial system as known from WO 2018/213 927 A1 is not suitable for capturing infrastructure elements of underground line networks in a distribution network, or may pose an additional hazard for the construction site employees and/or passers-by in the vicinity. From a technical standpoint, moreover, this method is inadequate particularly in town/city areas, since sensor-typical and undesired drift effects and also inaccuracies resulting therefrom occur when local point clouds are generated solely using LIDAR. These drift effects and inaccuracies make it impossible to carry out capture with an absolute accuracy in the single-digit centimeter range—as required when mapping exposed infrastructure elements of underground line networks in a distribution network.

U.S. Pat. No. 9,230,453 B2 describes a method for capturing an exposed infrastructure element in which a QR code attached to the infrastructure element manually is read by means of a LIDAR scanner or one or more cameras in order to determine the attributes thereof. A method for capturing exposed infrastructure elements with absolute georeferencing is not described. In order to link the infrastructure elements with an absolute position, environment-relevant objects whose coordinates are already known in advance in the respective official coordinate system have to be provided with target markers and be captured by one or more cameras or LIDAR. These environment-relevant objects thus in turn have to be calibrated in a further previous step by experts using additional, conventional and expensive GNSS surveying equipment or tachymeter devices. The result of this is that overall there are not just many work steps susceptible to errors, but expert knowledge in the field of georeferencing is also presupposed and numerous sensor-specific drift effects and inaccuracies resulting therefrom are accepted, which make it impossible to carry out capture with an absolute accuracy in the single-digit centimeter range—as required when mapping exposed infrastructure elements of underground line networks in a distribution network. Furthermore, the method has a serious disadvantage owing to dependence on the recognition of the QR codes. If it is not possible to recognize the QR codes on account of contamination that is customary at construction sites, for instance as a result of dust, dirt or deposit of precipitation, the method cannot be used. The apparatus described in U.S. Pat. No. 9,230,453 B2 consists of a plurality of separate components: here the data are firstly captured by an apparatus such as, for example, a LIDAR system or a camera system having a plurality of cameras and are subsequently sent to a data processing system via a communication network. The separate data processing device converts the data into a 3D point cloud by means of the “AutoCAD” software, this then being followed by use of the “Photo Soft” software and also additional software for recognizing QR codes and target markers. In that case, said data have to be imported/exported manually between the programs. If an absolute georeferencing is necessary, a surveying system and a target marker must additionally be used.

### SUMMARY

Against this background, the problem addressed is that of enabling positionally correct capture of infrastructure elements of an underground line network, in particular in a distribution network, with an absolute accuracy of a few centimeters, with a reduced number of work steps, without expert knowledge and with compensation of virtually all disturbance influences and sensor-typical measurement uncertainties.

In order to solve the problem, what is proposed is a method for capturing exposed infrastructure elements of an underground line network, in particular in an open excavation, by means of a mobile capture apparatus, wherein:
by means of a 3D reconstruction device of the mobile capture apparatus, image data and/or depth data of a scene containing at least one exposed infrastructure element arranged underground are captured and a 3D point cloud having a plurality of points is generated on the basis of these image data and/or depth data;
by means of one or more receivers of the mobile capture apparatus, signals of one or more global navigation satellite systems are received and a first position indication of the position of the capture apparatus in a global reference system is determined; and
a plurality of second position indications of the position of the capture apparatus in a local reference system and a plurality of orientation indications of the orientation of the capture apparatus in the respective local reference system are determined,
   a. wherein the determination of one of the second position indications and of one of the orientation indications is effected by means of an inertial measurement unit of the mobile capture apparatus, which captures linear accelerations of the mobile capture apparatus in three mutually orthogonal principal axes of the local reference system and angular velocities of the rotation of the mobile capture apparatus about these principal axes, and
   b. wherein the 3D reconstruction device comprises one or more 2D cameras, by means of which the image data and/or the depth data of the scene are captured and the determination of one of the second position indications and of one of the orientation indications is effected by means of visual odometry on the basis of the image data and/or the depth data; and
   c. wherein the 3D reconstruction device comprises a LIDAR measuring device, by means of which the depth data of the scene are captured and the determination of one of the second position indications and of one of the orientation indications is effected by means of visual odometry on the basis of the depth data;
a respective georeference is allocated to the points of the 3D point cloud on the basis of the first position indication and a plurality of the second position indications and also a plurality of the orientation indications,
wherein the mobile capture apparatus is able to be carried by a person, wherein the mobile capture apparatus is able to be held by both hands of a person, preferably by one hand of a person, and has a housing, the largest edge length of which is less than 50 cm, wherein the receiver(s), the inertial measurement unit and the 3D reconstruction device are arranged in the housing.

Further subject matter of the invention is a mobile capture apparatus for the positionally correct capture of exposed infrastructure elements arranged underground, in particular in an open excavation, comprising:
a 3D reconstruction device for capturing image data and/or depth data of a scene containing at least one exposed infrastructure element arranged underground, and for generating a 3D point cloud having a plurality of points on the basis of these image data and/or depth data;
one or more receivers for receiving signals of one or more global navigation satellite systems and for determining a first position indication of the position of the capture apparatus in a global reference system;
an inertial measurement unit for determining a second position indication of the position of the capture apparatus in a local reference system and an orientation indication of the orientation of the capture apparatus in the local reference system, wherein the inertial measurement unit is designed to capture linear accelerations of the mobile capture apparatus in three mutually orthogonal principal axes of the local reference system and angular velocities of the rotation of the mobile capture apparatus about these principal axes;
and
wherein the 3D reconstruction device comprises one or more 2D cameras, by means of which image data of the scene are capturable, wherein a second position indication of the position of the capture apparatus in the local reference system and the orientation indication are determinable by means of visual odometry on the basis of the image data;
and
wherein the 3D reconstruction device comprises a LIDAR measuring device, by means of which depth data of the scene are capturable, wherein a second position indication of the position of the capture apparatus in the local reference system and the orientation indication are effected by means of visual odometry on the basis of the depth data;
wherein the capture apparatus is configured to allocate a respective georeference to the points of the 3D point cloud, on the basis of the first position indication and a plurality of the second position indications and also a plurality of the orientation indications;
wherein the mobile capture apparatus is able to be carried by a person, wherein the mobile capture apparatus is able to be held by both hands of a person, preferably by one hand of a person, and has a housing, the largest edge length of which is less than 50 cm, wherein the receiver(s), the inertial measurement unit and the 3D reconstruction device are arranged in the housing.

In the method according to the invention, the exposed infrastructure elements are captured by means of the mobile capture apparatus, wherein the latter comprises one or more receivers for receiving signals of one or more global navigation satellite systems and also the 3D reconstruction device and the inertial measurement unit. This combination of the receiver(s) for the signals of one or more global navigation satellite systems and the 3D reconstruction device and the inertial measurement unit enables simple capture of the position and orientation of the infrastructure elements in a geodetic reference system with high accuracy. A 3D point cloud of the recorded scene including the given infrastructure element or the given infrastructure elements is generated in this case. A respective georeference is allocated to the points of said 3D point cloud. In this context, georeference is understood to mean a position indication of a point of the 3D point cloud in a geodetic reference system, preferably in an official location reference system, for example ETRS89/UTM, in particular plus geometric and/or physical height reference.

The georeference is allocated to the points of the 3D point cloud on the basis of the first position indication—i.e. the determined position of the mobile capture apparatus in the global reference system—and on the basis of the plurality of second position indications—i.e. the estimated positions of the capture apparatus in the local reference system—and on the basis of the orientation indications—i.e. indications of the estimated orientation of the capture apparatus in the local reference system. The image data can thus have a position indication that is independent of reference points in the region of the respective infrastructure elements or excavation. As a result, the georeference can be determined with increased accuracy and reliability. According to the invention, arranging and capturing a control point or a marker—for instance in accordance with US 2014 210 856 A1—is not necessary, with the result that it is possible to save work steps during calibration. Consequently, as accurate and positionally correct capture of the exposed infrastructure elements as possible with a reduced number of work steps can be made possible.

By virtue of the common housing, a mobile capture apparatus for capturing the exposed infrastructure elements can be provided which is compact, robust and suitable for construction sites and which can be used alongside an open excavation and also enables use of the mobile capture apparatus where a person situated in the open excavation and holding the mobile capture apparatus in one or two hands uses it to capture the exposed infrastructure element or the exposed infrastructure elements. The method according to the invention and the mobile capture apparatus according to the invention can therefore be used particularly advantageously for capturing exposed infrastructure elements arranged underground in distribution networks particularly in a town/city environment.

Advantageous configurations of the invention are the subject matter of the dependent claims and relate equally to the method for capturing infrastructure elements and to the mobile apparatus for capturing infrastructure elements.

Within the meaning of the invention, underground infrastructure elements are understood to mean in particular line or cable elements such as, for example, fiber-optic cables, gas pipes, district heating pipes, water pipes, power or telecommunication cables and also associated conduits, cable ducts and connection elements. The connection elements can be embodied for example as connectors for exactly two line or cable elements, as distributors for connecting three or more line or cable elements, or as amplifier elements. The underground infrastructure elements to be captured are preferably such underground infrastructure elements which are part of a distribution network, in particular part of a fiber-optic, power or telecommunication cable distribution network.

The underground infrastructure elements preferably have a diameter of less than 30 cm, preferably less than 20 cm, particularly preferably less than 10 cm, for example less than 5 cm.

Preferably, in the method according to the invention, image data and/or depth data of a plurality of frames of a scene containing a plurality of exposed infrastructure elements arranged underground are captured and a 3D point cloud having a plurality of points is generated on the basis of these image data and/or depth data.

Preferably, the receiver(s) is/are designed to receive and process signals of a global navigation satellite system. It is particularly preferred if the receiver(s) is/are designed to simultaneously capture and process signals of a plurality of global navigation satellite systems (GNSS), in particular signals from satellites of different global navigation satellite systems and in a plurality of frequency bands. The global navigation satellite systems can be for example GPS, GLONASS, Galileo or Beidou. The receiver(s) can alternatively or additionally be designed to receive signals, in particular reference or correction signals, from land-based reference stations. By way of example, the receiver(s) can be designed to receive the signals of the land-based transmitting station via a mobile radio network. The correction signals can be for example SAPOS correction signals (German satellite positioning service) or signals of the global HxGN SmartNet. Preferably, for determining the position of the capture apparatus, use is made of one or more of the following methods: real time kinematic (referred to as RTK), precise point positioning (PPP), post processed kinematic (PPK). The use of one or more of these methods makes it possible for the accuracy when determining the position of the capture apparatus to be reduced to a range of less than 10 cm, preferably less than 5 cm, particularly preferably less than 3 cm, for example less than 2 cm. In order to ensure the quality of the determined first position indications in the global reference system, a quality investigation of the georeferencing can be carried out, in manner not visible to the user. This is done by monitoring preferably one or more quality parameters of the global satellite navigation systems, for example DOP (dilution of precision).

The inertial measurement unit (IMU) is preferably designed to capture in each case a translational movement in three mutually orthogonal spatial directions—e.g. along an x-axis, a y-axis and a z-axis—and in each case a rotational movement about these three spatial directions—e.g. about the x-axis, the y-axis and the z-axis—, in particular to repeat these data captures a number of times at time intervals. By way of example, the inertial measurement unit can capture three linear acceleration values for the translational movement and three angular velocities for the rotation rates of the rotational movement as observation variables. These observation variables can be derived on the basis of proportional ratios of measured voltage differences. With the aid of further methods such as the strapdown algorithm (SDA), for example, changes in position, velocity and orientation can be deduced by means of the measured specific force and the rotation rates.

The 3D reconstruction device can comprise a time-of-flight camera, a structured light camera, a stereo camera, a LIDAR measuring device, a RADAR measuring device and/or a combination thereof among one another, in particular with one or more 2D cameras.

The LIDAR measuring device of the 3D reconstruction device is preferably configured as a solid-state LIDAR measuring device (referred to as solid-state LIDAR or flash LIDAR). Such solid-state LIDAR measuring devices afford the advantage that they can be configured without mechanical components. A further advantage of the solid-state LIDAR measuring device is that the latter can capture image and/or depth information of a plurality of points at the same point in time, such that distortion effects on account of moving objects in the field of view cannot occur in the case of the solid-state LIDAR measuring device. Measures for correcting such distortions that occur in the case of scanning LIDAR measuring devices with a rotating field of view can therefore be dispensed with.

According to the invention, the mobile capture apparatus comprises a housing, wherein the receiver(s), the inertial measurement unit and the 3D reconstruction device are arranged in the housing. It is advantageous if the mobile capture apparatus does not have a frame on which the receiver(s), the inertial measurement unit and the 3D reconstruction device are arranged in an exposed manner. By virtue of the common housing, it is possible to provide a capture apparatus for capturing the exposed infrastructure elements which is compact and robust, mobile and suitable for construction sites.

The invention provides for the mobile capture apparatus to be able to be carried by a person, wherein the capture apparatus is able to be held by both hands of a person, preferably by one hand of a person, such that the mobile capture apparatus can be carried by the user to an open excavation and be used there to capture exposed infrastructure elements. According to the invention, the mobile capture apparatus has a housing, the largest edge length of which is less than 50 cm, preferably less than 40 cm, particularly preferably less than 30 cm, for example less than 20 cm. The invention provides, in particular, for the mobile capture apparatus not to be embodied as an unmanned aerial vehicle. The invention provides, in particular, for the mobile capture apparatus not to be able to be secured, preferably not to be secured, to a ground machine or a ground vehicle.

Preferably, the georeference is determined exclusively by means of the mobile capture apparatus—for example by means of the one or more receivers for signals of one or more global navigation satellite systems, the inertial measurement unit and the 3D reconstruction device. Preferably, a plurality of points, in particular all points, of the 3D point cloud comprise a position indication in a geodetic reference system as a result of the georeferencing. The geodetic reference system can be identical with the global reference system.

In accordance with one advantageous configuration of the method, it is provided that respective color or grayscale value information is assigned to the points of the 3D point cloud, wherein the color or grayscale value information is preferably captured by means of the one or more 2D cameras of the 3D reconstruction device. The color or grayscale value information can be present for example as RGB color information in the RGB color space or HSV color information in the HSV color space.

In accordance with one advantageous configuration of the method, a textured mesh model is generated on the basis of the 3D point cloud and the image data of the one or more 2D cameras. The use of a textured mesh model makes it possible to reduce the amount of data to be stored.

In accordance with one advantageous configuration, it is provided that
the first position indication of the position in the global reference system and/or raw data assigned to this position indication; and
the one or more second position indications; and
the one or more second orientation indications; and
the captured image data and/or the captured depth data and/or the captured linear accelerations of the mobile capture apparatus in three mutually orthogonal principal axes of the local reference system and also the angular velocities of the rotation of the mobile capture apparatus about these principal axes;
   are stored in a temporally synchronized manner, in particular in a storage unit of the capture apparatus. For the purpose of synchronization, provision can be made for a common time stamp and/or a common frame designation to be stored in this case. The mobile capture apparatus preferably comprises a storage unit designed to store in a temporally synchronized manner the first position indication of the position in the global reference system and/or raw data assigned to this position indication; and the one or more second position indications; and the one or more second orientation indications; and the captured image data and/or the captured depth data and/or the captured linear accelerations of the mobile capture apparatus in three mutually orthogonal principal axes of the local reference system and also the angular velocities of the rotation of the mobile capture apparatus about these principal axes.

In accordance with one advantageous configuration, it is provided that, in particular for determining and/or for allocating the georeference, the one or more second position indications are transformed from the respective local reference system into the global reference system, preferably by means of a rigid body transformation or Helmert transformation or by means of a principal axis transformation. Optionally, the first position indication in the global reference system and the one or more second position indications in the respective local reference system can be transformed into a further reference system.

In accordance with one advantageous configuration, it is provided that the determination of one of the second position indications and of one of the orientation indications is effected by means of visual odometry on the basis of the image data and/or the depth data and/or by means of the inertial measurement unit by simultaneous position determination and mapping. The determination of the one or more second position indications and of the orientation indications contributes to an improved georeferencing of the points of the 3D point cloud by enabling a more accurate determination of the trajectory of the capture apparatus.

It is advantageous if allocating the georeference to the points of the 3D point cloud is effected by means of sensor data fusion, wherein a factor graph as a graphical model and/or an applied estimation method are/is preferably used for optimization purposes, wherein the first position indications of the position in the global reference system are preferably used. In this regard, in particular, drift effects and deviations between the second position indications and the first position indications in the global reference system of the capture apparatus can be recognized and corrected. The capture of the first position indications by the one or more incorporated receivers in a global reference system can compensate for the limiting factors—having short-term stability
of the relative sensor systems and lead to the georeferencing of the mobile capture apparatus with the aid of a transformation into the superordinate coordinate system.

In one advantageous configuration, the sensor data fusion is based on a nonlinear equation system, on the basis of which an estimation of the position and of the orientation of the mobile capture apparatus is effected. Preferably, an estimation of the trajectory, i.e. of the temporal profile of the position of the mobile capture apparatus, and an estimation of the temporal profile of the orientation of the mobile capture apparatus are effected on the basis of the nonlinear equation system. The estimation of position and orientation or trajectory and profile of the orientation makes it possible to achieve firstly a high absolute accuracy of the georeferencing in the range of a few centimeters and secondly the advantage that it is possible to compensate for an occasional failure of a sensor, e.g. if reliable first position indications cannot be determined on account of limited satellite visibility.

It is preferred if on the basis of the image data and/or depth data captured by the 3D reconstruction device, at least one infrastructure element, in particular a line or a connection element, is detected and classified and the estimation of the position and of the orientation of the mobile capture apparatus on the basis of the nonlinear equation system is additionally effected on the basis of the results of the detection and classification of the infrastructure element, in particular on the basis of result indications containing color information and/or line diameter and/or a course and/or a bending radius and/or georeference. A particularly robust and precise georeferencing of the infrastructure elements can be achieved in the case of such a configuration.

A factor graph is preferably used for the purpose of sensor data fusion, which factor graph maps the complex relationships between different variables and factors. In this context, the motion information (angular velocities, orientation indications, etc.) added sequentially for each frame can be fused with carrier phase observations (GNSS factors) in a bundle adjustment. In this case, the GNSS factors represent direct observations of the georeferenced position of a frame, whereas the relative pose factors yield information about the changes in pose between the frames and feature point factors link the local location references (e.g. recognizable structures and/or objects) detected in the image recordings and establish the spatial reference to the surroundings. Furthermore, the results of the detection, classification and/or segmentation of infrastructure elements (color information, geometric application-specific features such as e.g. diameter, course, bending radii, first/second position indications of the mobile capture apparatus, etc.) can concomitantly influence the sensor data fusion mentioned above. What arises as the result is a continuous, globally fully, newly aligned 3D point cloud of recorded frames of a scene, on the basis of which all infrastructure elements can be extracted three-dimensionally, in a georeferenced manner with an absolute accuracy of a few centimeters.

In accordance with one advantageous configuration, it is provided that by means of the one or more receivers of the mobile capture apparatus, signals from a maximum of three navigation satellites of the global navigation satellite system are received, wherein a respective georeference is allocated to the points of the 3D point cloud with an accuracy in the range of less than 10 cm, preferably less than 5 cm, particularly preferably less than 3 cm. Owing to the use of a plurality of sensor data sources, three-dimensional absolute geocoordinates of infrastructure elements in environments in which there is only limited satellite visibility and/or poor mobile radio coverage can be determined in the range of a few centimeters.

In accordance with one advantageous configuration, it is provided that the second position indications of the position of the capture apparatus and/or the orientation indications of the mobile capture apparatus as prior information assist the resolution of ambiguities of differential measurements of carrier phases in order to georeference infrastructure elements even if the receiver reports a failure or determines a usable second position indication and/or orientation indication only for a short time by means of the inertial measurement unit.

It is advantageous if with the aid of the sensor data fusion regions of infrastructure elements recorded multiply or at different times, such as overlaps between two scenes, for example, are recognized and reduced to the temporally most recent captured region of the infrastructure elements.

One advantageous configuration provides for a plausibility of a temporal sequence of first position indications of the position of the capture apparatus in the global reference system to be determined, preferably by a first velocity indication being determined on the basis of the temporal sequence of first position indications and a second velocity indication being calculated on the basis of the captured linear accelerations and angular velocities and being compared with the first velocity indication. A comparison with the time integral of the linear accelerations can be effected for this purpose. The reliability of the georeference determined or allocated to the points can be increased as a result. Preferably, a respective georeference is thus allocated to the points of the 3D point cloud on the basis of one or more first position indications and one or more of the second position indications and one or more of the orientation indications and the measured accelerations of the mobile capture apparatus along the principal axes of the local reference system and the measured angular velocities of the rotations of the mobile capture apparatus about these principal axes.

One advantageous configuration provides for, on the basis of the 3D point cloud and/or on the basis of the image data, at least one infrastructure element, in particular a line or a connection element, to be detected and/or classified and/or segmented.

In this context, it is preferred if one or more methods of image segmentation such as, for example, threshold value methods, in particular histogram-based methods, or texture-oriented methods, or region-based methods, or else pixel-based methods such as, for example, support vector machine, decision trees and neural networks are used for the detection, classification and/or segmentation of an infrastructure element. By way of example, for the detection, classification and/or segmentation of the infrastructure elements, color information of the captured image data can be compared with predefined color information. Since infrastructure elements of different line networks generally have a different coloration and/or different geometry information, color information and/or geometry information of the captured image data can be compared with, for example, predefined color information and/or geometry information stored in a database in order firstly to differentiate the infrastructure elements from their surroundings in the scene and secondly to recognize the type of infrastructure element, for example whether the latter is a fiber-optic cable or a district heating pipe. Preferably, color information of the points of the 3D point cloud is compared with predefined color information, such that points of the 3D point cloud can be assigned directly to a recognized infrastructure element.

In accordance with one advantageous configuration, it is provided that at least one histogram of color and/or grayscale value information, and/or saturation value information and/or brightness value information and/or of an electromagnetic wave spectrum of a plurality of points of the 3D point cloud is generated for the detection, classification and/or segmentation. Generating a histogram of the color or grayscale value information makes possible, in a first step, the assignment of the points of the point cloud which are most nearly similar to the predefined color and/or grayscale value information, and/or saturation value information and/or brightness value information and/or an electromagnetic wave spectrum and thus establish the basis for an improved recognition of infrastructure elements in a scene. Preferably, a histogram of color or grayscale value information of the image data in the HSV color space is generated, for example after a preceding transformation of the image data into the HSV color space. Particularly preferably, the histogram of the color value (referred to as hue) is generated, which is also referred to as color angle.

Preferably, in the histogram or histograms local maxima are detected and among the local maxima such maxima with the smallest separations with respect to a predefined color, saturation and brightness threshold value of an infrastructure element are determined or detected.

It has proved to be advantageous if a group of points whose points do not exceed a predefined separation threshold value with respect to the color information composed of the detected local maxima is extended iteratively by further points which do not exceed a defined geometric and color separation with respect to the associated neighboring points, in order to form a locally continuous region of an infrastructure element with similar color information. In this way, it is possible to detect locally continuous regions of an infrastructure element with a similar color value. An infrastructure element whose color value changes gradually in the geometric course of the infrastructure element can also be recognized as a continuous infrastructure element in the image data. Preferably, a preferred direction separation threshold value can be predefined for a preferred spatial direction corresponding to a direction of movement of the mobile capture apparatus during the capture of the infrastructure element. The preferred direction separation threshold value can be greater than the separation threshold value for other spatial directions since it can be assumed that during the capture of the infrastructure elements in the open excavation the user moves the mobile capture apparatus in a direction corresponding to the main direction of extent of the infrastructure elements.

One advantageous configuration of the invention provides that for the detection, classification and/or segmentation of the infrastructure elements and/or for improved distance measurement and/or for initialization of the absolute orientation, a light spot of a laser pointer of the capture apparatus is captured and/or displayed in the display direction. For this purpose, the mobile capture apparatus preferably comprises a laser pointer for the optical marking of infrastructure elements, by means of which laser pointer a laser beam directed in the direction of the scene captured by the 3D reconstruction device is preferably able to be generated. By means of the laser pointer, a user of the capture apparatus can mark a point in the captured scene which represents a part of the infrastructure element. The point marked by means of the laser pointer can be identified in the captured image data and points having a geometric separation from the marked point can represent candidate points that are presumably likewise part of the infrastructure element. In a further step, the color values of the candidate points can be compared with one another, for example by means of one or more histograms. From the latter it is possible to detect the local maxima with the smallest separations with respect to the previously defined hue, saturation and brightness values of the infrastructure element.

One advantageous configuration of the method according to the invention provides that for the detection, classification and/or segmentation of the infrastructure elements, color or grayscale value information of the captured image data, in particular color or grayscale value information of the points of the 3D point cloud, and/or the captured depth data and associated label information are fed to one or more artificial neural networks for training purposes. In the context of training the artificial neural network, the image data can be used as training data for the artificial neural network, wherein correction data are additionally provided by a user of the capture apparatus in order to train the artificial neural network. The artificial neural network can be embodied as part of a data processing device of the mobile capture apparatus, in particular as software and/or hardware. Alternatively, it is possible for the artificial neural network to be provided as part of a server to which the mobile capture apparatus is connected via a wireless communication connection. By means of the trained neural network, a detection, classification and/or segmentation of infrastructure elements can be made possible with reduced computational complexity.

One advantageous configuration provides that for each detected infrastructure element an associated 3D object is generated, in particular on the basis of the 3D point cloud. The generating of the 3D object is preferably effected proceeding from the 3D point cloud in the geodetic reference system and is thus georeferenced. The 3D object can have a texture. Preferably, the mobile capture apparatus comprises a graphics processing unit (GPU) designed to represent the 3D object corresponding to the captured infrastructure element.

During the capture of infrastructure elements in a distribution network, for various reasons the situation can arise that a part of the infrastructure element arranged underground is not optically capturable by the mobile capture apparatus on account of concealment. Optical vacancies thus arise in the 3D point cloud or the network defined by the 3D objects. Such a situation may arise for example if the infrastructure element is covered by a plate extending over the excavation, for example a steel plate forming a crossing over the excavation. Furthermore, it is possible for the exposed infrastructure element to be connected to a further infrastructure element with the latter having been laid in a closed manner of construction, thus e.g. by means of press drilling. Furthermore, e.g. as a result of inattentive movements of a user of the mobile capture apparatus, it can happen that infrastructure elements or parts thereof are concealed by sand or soil, or foliage may fall from nearby trees and result in concealments. Measures can be taken to enable the additional capture of such infrastructure elements that are not optically capturable by the mobile capture apparatus, which measures are presented below.

One advantageous configuration of the invention provides that an optical vacancy between two 3D objects is recognized and a connection 3D object, in particular as a 3D spline, is generated for closing the optical vacancy.

Preferably, for recognizing the optical vacancy, a feature of a first end of a first 3D object and the same feature of a second end of a second 3D object are determined, wherein the first and second features are compared with one another and the first and second features are a diameter or a color or an orientation or a georeference. Particularly preferably, for recognizing the optical vacancy, a plurality of features of a first end of a first 3D object and the same features of a second end of a second 3D object are determined, wherein the first and second features are compared with one another and the first and second features are a diameter and/or a color and/or an orientation and/or a georeference.

Alternatively, it can be provided that the mobile capture apparatus is put into an optical vacancy mode and is moved proceeding from the first end to the second end. The optical vacancy mode can be activatable by an operator control element of the capture apparatus.

In accordance with one advantageous configuration, it is provided that the mobile capture apparatus comprises a device for voice control. An auditory input of commands and/or information can be effected via the device for voice control. An auditory input makes it possible to prevent undesired blurring as a result of the actuation of operator control elements during the capture of infrastructure elements, which contributes to improved capture results. Furthermore, an acoustic output of input requests and/or information, in particular feedback messages and/or warnings, can be effected by means of the device for voice control. The device for voice control can comprise one or more microphones and/or one or more loudspeakers.

Preferably, auditory information is recognized by means of the device for voice control and the georeference is allocated to the points of the 3D point cloud additionally on the basis of the auditory information. Particularly preferably, the auditory information, in particular during the sensor data fusion, is used for the estimation of the position and the orientation of the mobile capture apparatus. Alternatively or additionally, the auditory information can be used for the detection and classification of the infrastructure elements. By way of example, auditory information of a user concerning the type of infrastructure element to be recognized (“the line is a fiber-optic cable”) and/or concerning the number of infrastructure elements to be recognized (“three lines are laid”) and/or concerning the arrangement of the infrastructure elements (“on the left there is a gas pipe, and on the right a fiber-optic cable”) can be recognized by means of the device for voice control. It is preferably provided that on the basis of the image data and/or depth data captured by the 3D reconstruction device, at least one infrastructure element, in particular a line or a connection element, is detected and classified and the estimation of the position and of the orientation of the mobile capture apparatus on the basis of the nonlinear equation system is additionally effected on the basis of auditory information.

In accordance with one advantageous configuration, it is provided that by means of a display device of the mobile capture apparatus, a representation of the 3D point cloud and/or 3D objects corresponding to infrastructure elements are/is displayed. This affords the advantage that the user of the mobile capture apparatus can view and optionally check the 3D point cloud and/or 3D objects corresponding to infrastructure elements on site, for example directly after the capture of the infrastructure elements in the open excavation.

Alternatively or additionally, by means of the display device, a textured mesh model generated on the basis of the 3D point cloud and the image data of the one or more 2D cameras can be displayed.

In accordance with one advantageous configuration, it is provided that by means of a display device of the mobile capture apparatus, a 2D location plan is displayed. The 2D location plan can be generated by means of a data processing device of the mobile capture apparatus, for example on the basis of the in particular georeferenced 3D point cloud. Preferably, the 2D location plan can be stored in a file, for example in the .dxf file format or shapefiles with individual attributes. The configuration of such a 2D location plan serves for digitally integrating the infrastructure elements into the individual geoinformation systems of the responsible owners.

In accordance with one advantageous configuration, it is provided that by means of a display device of the mobile capture apparatus, a parts list of infrastructure elements, in particular of line elements and connection elements, is displayed. The parts lists can be generated by means of a data processing device of the mobile capture apparatus on the basis of the detected, classified and/or segmented infrastructure elements and can be manually adapted by the user. The parts list can comprise for example infrastructure elements of different line networks. The parts list can comprise for example information about the number of respective infrastructure elements and/or the number of laid length units of the respective infrastructure elements and/or the position indication of the respective infrastructure element in a geodetic reference system and/or the progress of construction.

In accordance with one advantageous configuration, it is provided that by means of a display device of the mobile capture apparatus, a superposition of image data of a 2D camera of the capture apparatus with a projection of one or more 3D objects corresponding to an infrastructure element is displayed. In order to project the 3D object of the infrastructure element onto the excavation, firstly the orientation of the camera viewing direction of the mobile capture apparatus has to be initialized. For this purpose, it is necessary for the user to move the mobile capture apparatus to the locality for example over a range of a few meters or to carry out a specific movement pattern/procedure in order to acquire the orientation in space by way of sufficient sensor data of the mobile capture apparatus. Preferably, a superposition of the image data of the 2D camera provided as part of the 3D reconstruction device with a plurality of projections of the 3D objects corresponding to a plurality of, in particular interconnected, infrastructure elements is displayed. Such a representation may also be referred to as an “augmented reality” representation and enables a realistic or positionally correct representation of the infrastructure elements arranged in a concealed manner, even in the closed state. That means that, by means of the mobile capture apparatus, a realistic representation of the infrastructure elements laid underground can be represented to a user even after the excavation has been closed. On account of the georeferenced image data, the user does not have to expose the infrastructure elements in order to be able to perceive their course with high accuracy.

In accordance with one advantageous configuration, it is provided that by means of a display device of the mobile capture apparatus, a superposition of image data of a 2D camera—provided as part of the 3D reconstruction device—of the capture apparatus with a projection of a plurality of points of the 3D point cloud is displayed. If a projection of the 3D point cloud is displayed on the display device, this does result in an increased computational complexity during the representation by comparison with the representation of the projection of a 3D object. However, a preceding generation of the 3D object can then be dispensed with.

The mobile capture apparatus preferably comprises a display device for displaying display data and a data processing device designed to provide display data comprising
a representation of the 3D point cloud and/or
a textured mesh model generated on the basis of the 3D point cloud and the image data of the one or more 2D cameras and/or
3D objects corresponding to infrastructure elements and/or
a 2D location plan and/or
a parts list of infrastructure elements and/or
a superposition of image data of a 2D camera of the capture apparatus with a projection of one or more 3D objects corresponding to an infrastructure element and/or
a superposition of image data of a 2D camera of the capture apparatus with a projection of a plurality of points of the 3D point cloud.

The display device can be embodied as a combined display and operator control device that can be used to capture a user's inputs, for example as a touchscreen.

In accordance with one advantageous configuration, the mobile capture apparatus comprises a laser pointer for optically marking infrastructure elements and/or for extended distance measurement and/or for initializing the orientation in the display direction.

In accordance with one advantageous configuration, the mobile capture apparatus comprises a polarization filter for avoiding glare, specular reflection and reflections for the purpose of increasing quality and optimization of the observation data.

In accordance with one advantageous configuration, the mobile capture apparatus comprises one or more illumination devices for improved detection, classification and/or segmentation of infrastructure elements.

In accordance with one advantageous configuration, the mobile capture apparatus comprises a device for voice control.

Preferably, the device for voice control is designed to enable an acoustic output of input requests and/or information, in particular feedback messages and/or warnings.

### BRIEF DESCRIPTION OF THE DRAWINGS

Further details and advantages of the invention shall be explained below on the basis of the exemplary embodiments shown in the figures. The following is shown herein:

FIG. 1 shows one exemplary embodiment of a mobile capture apparatus according to the invention in a schematic block illustration;

FIG. 2 shows one exemplary embodiment of a method according to the invention for capturing exposed infrastructure elements situated underground in a flow diagram;

FIG. 3 shows one exemplary projection of a 3D point cloud;

FIG. 4 shows one exemplary representation of a scene;

FIGS. 5, 6 show representations of construction projects in which the invention can be used;

FIG. 7 shows a block diagram for elucidating the processes when allocating the georeference to the points of the 3D point cloud;

FIG. 8 shows a schematic representation of a plurality of scenes;

FIG. 9a shows a plan view of an excavation with a plurality of at least partly optically concealed infrastructure elements; and

FIG. 9b shows a plan view of the excavation in accordance with FIG. 9a with a recognized and closed optical vacancy.

### DETAILED DESCRIPTION

FIG. 1 illustrates a block diagram of one exemplary embodiment of a mobile capture apparatus 1 for capturing exposed infrastructure elements situated underground, in particular in an open excavation. The mobile capture apparatus 1 comprises, inter alia, one or more receivers 2, consisting of a receiving installation for receiving and processing signals of one or more global navigation satellite systems and for determining a first position of the capture apparatus in the global reference system on the basis of time-of-flight measurements of the satellite signals. The receiver 2, in particular the receiving installation of the receiver 2, can be connected to one or more antennas, preferably arranged outside the housing 9 of the mobile capture apparatus 1, particularly preferably on an outer contour of the housing 9. Alternatively, the antenna can be arranged within the housing 9. This first position of the capture apparatus 1 in the global reference system can be improved in particular by means of a reference station or the service of a reference network. The mobile capture apparatus 1 also contains a 3D reconstruction device 4 for capturing image data and/or depth data of a scene, in particular of a frame of a scene containing exposed infrastructure elements situated underground. Furthermore, the mobile capture apparatus 1 comprises an inertial measurement unit 3 for measuring the accelerations along the principal axes and the angular velocities of the rotations of the mobile capture apparatus 1. Furthermore, a plurality of second position indications of the position of the capture apparatus are estimated by means of visual odometry of the image data and/or depth data and by means of an inertial measurement unit 3 by simultaneous position determination and mapping. In particular, the plurality of second position indications of the position of the capture apparatus 1 in a local reference system and the plurality of orientation indications of the orientation of the capture apparatus 1 in the respective local reference system are determined,
a. wherein the determination of one of the second position indications and of one of the orientation indications is effected by means of an inertial measurement unit 3 of the mobile capture apparatus 1, which captures linear accelerations of the mobile capture apparatus 1 in three mutually orthogonal principal axes of the local reference system and angular velocities of the rotation of the mobile capture apparatus 1 about these principal axes, and/or
b. wherein the 3D reconstruction device 4 comprises one or more 2D cameras, by means of which the image data and/or the depth data of the scene are captured and the determination of one of the second position indications and of one of the orientation indications is effected by means of visual odometry on the basis of the image data and/or the depth data; and/or
c. wherein the 3D reconstruction device 4 comprises a LIDAR measuring device, by means of which the depth data of the scene are captured and the determination of one of the second position indications and of one of the orientation indications is effected by means of visual odometry on the basis of the depth data.

The receiver(s) 2, the inertial measurement unit 3 and the 3D reconstruction device 4 are arranged in a common housing 9.

The housing 9 has dimensions which make it possible that the mobile capture apparatus 1 can be held by a user by both hands, preferably in a single hand. The housing 9 has a largest edge length that is less than 50 cm, preferably less than 40 cm, particularly preferably less than 30 cm, for example less than 20 cm.

Further components of the mobile capture apparatus 1 that are likewise arranged in the housing 9 are a laser pointer 5, a data processing device 6, a storage unit 7, a communication device 10 and a display device 8.

The laser pointer 5 can be used for the optical marking of infrastructure elements and/or for supplementary distance measurement and is arranged in the housing or frame 9 in such a way that a laser beam that points in the direction of the scene captured by the 3D reconstruction device 4, for example at the center of the scene captured by the 3D reconstruction device 4, is generable by said laser pointer.

The data processing device 6 is connected to the receiver(s) 2, the inertial measurement unit 3 and the 3D reconstruction device 4, such that the individual measured and estimated data and also the image data can be fed to the data processing device 6. Furthermore, the laser pointer 5, the storage unit 7 and the display device 8 are connected to the data processing device 6.

The capture apparatus 1 contains a communication device 10 configured in particular as a communication device for wireless communication, for example by means of Bluetooth, WLAN or mobile radio.

The display device 8 serves for visualizing the infrastructure elements captured by means of the capture apparatus 1. The display device 8 is preferably embodied as a combined display and operator control device, for example in the manner of a touch-sensitive screen (referred to as touchscreen).

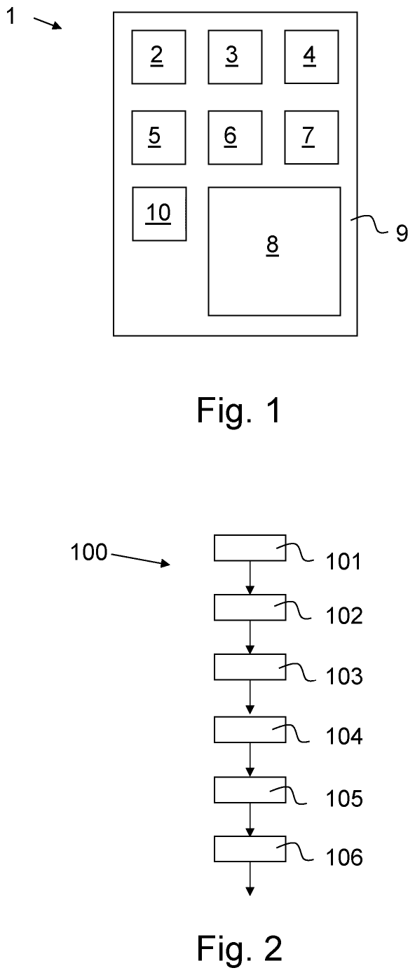

The mobile capture apparatus 1 shown in FIG. 1 can be used in a method for capturing exposed infrastructure elements situated underground. One exemplary embodiment of such a method 100 shall be explained below with reference to the illustration in FIG. 2.

In the method 100 for capturing infrastructure elements of an underground line network in an open excavation by means of a mobile capture apparatus 1, in a capturing step 101, by means of one or more receivers 2 of the mobile capture apparatus 1, signals of one or more global navigation satellite systems are received and processed and also one or more position indications of the position of the capture apparatus 1 in the global reference system are determined. At the same time, by means of a 2D camera of the mobile capture apparatus 1, said 2D camera being provided as part of the 3D reconstruction device 4, image data of a scene containing exposed infrastructure elements situated underground are captured. A LIDAR measuring device of the 3D reconstruction device captures image data and/or depth data of the scene. Furthermore, a plurality of second position indications of the position of the capture apparatus are estimated by means of visual odometry of the image data and/or depth data and by means of an inertial measurement unit 3 by simultaneous position determination and mapping. The inertial measurement unit 3 is designed to capture linear accelerations of the mobile capture apparatus 1 in three mutually orthogonal principal axes of the local reference system and angular velocities of the rotation of the mobile capture apparatus 1 about these principal axes. The capture apparatus 1 is carried by a person, preferably by both hands of a person, particularly preferably by one hand of a person.

The estimated second position indications in the local system, the estimated orientation indications in the local reference system, the measured first position in the global reference system, the measured accelerations along the principal axes and the measured angular velocities of the rotations of the mobile capture apparatus 1 about the principal axes and the captured image data are stored in a synchronized manner in the storage unit 7 of the capture apparatus 1. The user can move with the capture apparatus 1 during the capturing step 101, for example along an exposed infrastructure element. The synchronized storage of these data ensures that the data can be processed correctly in the subsequent method steps. The image data captured by the 3D reconstruction device are conditioned in a subsequent reconstruction step 102 in such a way that they generate a 3D point cloud having a plurality of points and color information for the points. In this respect, this is referred to here as a colored 3D point cloud.

In a georeferencing step 103, a first position indication in a geodetic reference system, for example an officially recognized coordinate system, is then allocated to the points of the 3D point cloud on the basis of the estimated second position indications of the 3D reconstruction device 4 in the local reference system, the estimated orientations of the 3D reconstruction device 4 in the local reference system and the measured first positions of the mobile capture apparatus 1 in the global reference system and the measured accelerations of the mobile capture apparatus 1 along the principal axes and the measured angular velocities of the rotations of the mobile capture apparatus 1 about the principal axes of the mobile capture apparatus 1. In this respect, after the georeferencing step 103 a colored, georeferenced 3D point cloud is calculated and provided.

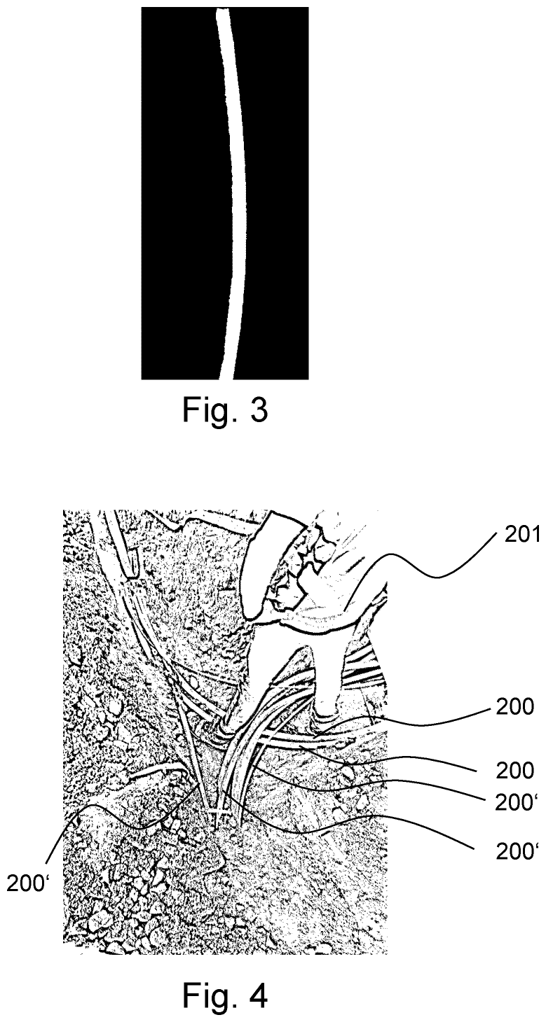

Afterward, in a recognition step 104, infrastructure elements are detected on the basis of the color information of the data. For the detection, classification and/or segmentation of the infrastructure elements, color information of the captured image data is compared with predefined color information. Alternatively or additionally, a marking of the infrastructure elements may have been effected by the user during the capture of the scene by means of the laser point 5. The marking by the laser point 5 can be detected in the image data and used for detecting the infrastructure elements. As a result of the recognition step 104, a plurality of image points of the image data, in particular a plurality of points of the colored, georeferenced 3D point cloud, are allocated in each case to a common infrastructure element, for example a line element or a line connection element. The illustration in FIG. 3 shows one exemplary image representation of a recognized infrastructure element in a 2D projection.

In a subsequent data conditioning step 105, the generated data of the individual recognition step are conditioned and the infrastructure elements thereof are detected. The conditioning can be effected by means of the data processing device 6. In this case, various types of conditioning are possible, which can be carried out alternatively or cumulatively: in the data conditioning step 105, 3D objects corresponding to the captured infrastructure elements can be generated, such that a 3D model of the underground line network is generated. Furthermore, a projection of the 3D point cloud can be calculated. It is possible to generate a 2D location plan in which the detected infrastructure elements are reproduced. Furthermore, a parts list of the recognized infrastructure elements can be generated.

In a visualization step 106, by means of the display device 8 of the mobile capture apparatus 1,
a representation of the 3D point cloud and/or
a 2D location plan and/or
a parts list of infrastructure elements and/or
a superposition of image data of a 2D camera of the capture apparatus with a projection of one or more 3D objects corresponding to an infrastructure element and/or
a superposition of image data of a 2D camera of the capture apparatus with a projection of a plurality of points of the 3D point cloud
   can then be displayed.

FIG. 4 visualizes an application of the method according to the invention and of the apparatus according to the invention. A plurality of frames of a recorded scene containing a multiplicity of infrastructure elements 200, 200′ of a distribution network are illustrated. The infrastructure elements 200, 200′ are fiber-optic cables and telecommunication cables, which are laid in a common excavation in some instances without a spacing between one another. The diameter of these infrastructure elements 200, 200′ is less than 30 cm, in some instances less than 20 cm. Some infrastructure elements 200′ have a diameter of less than 10 cm. A person 201 is standing in the open excavation and using a mobile capture apparatus 1 (not visible in FIG. 4) for capturing the exposed infrastructure elements 200, 200′ by means of the method according to the invention.

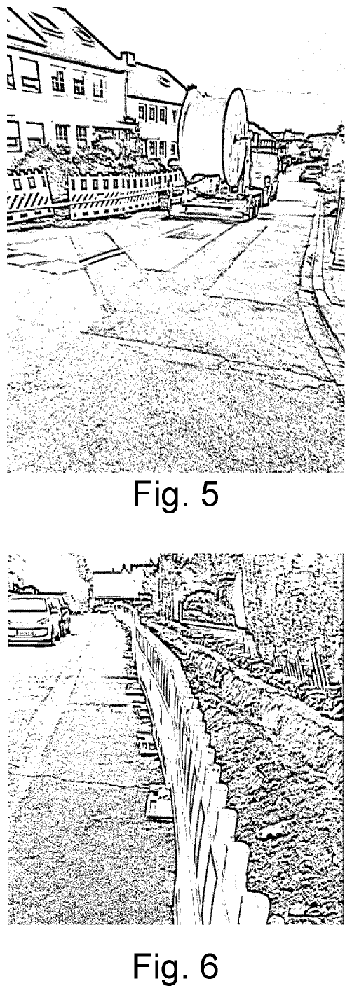

The representations in FIGS. 5 and 6 show typical construction sites for laying infrastructure elements of underground distribution networks in a town/city environment. These construction sites are situated in a town/city road area and are distinguished by excavations having a depth of 30 cm to 2 m. Around the excavation the space available is restricted and accessibility to the excavation is limited in part by parked automobiles and/or constant road traffic. The town/city environment of the excavation is often characterized by shading of the GNSS signals and of mobile radio reception.

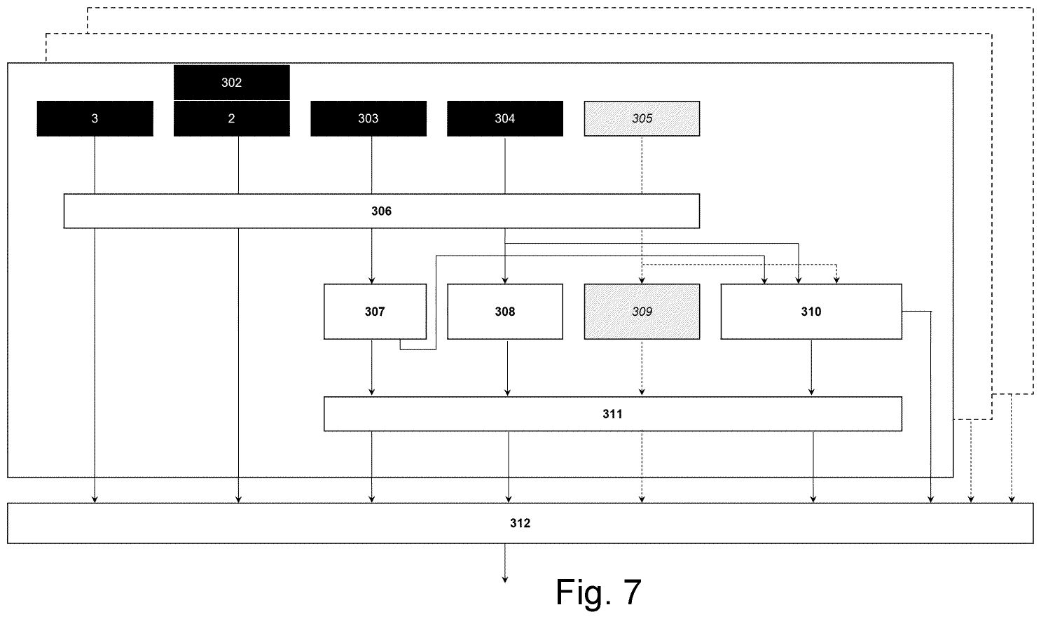

FIG. 7 shows a block diagram illustrating the data flow for generating the 3D point cloud and allocating the georeferences to the points of the point cloud. As data sources or sensors, the mobile capture apparatus 1 comprises the inertial measurement unit 3, the receiver 2 for the signals of the global navigation satellite system including mobile radio interface 302, a LIDAR measuring device 303—embodied here as a solid-state LIDAR measuring device—of the 3D reconstruction device 4 and also a first 2D camera 304 of the 3D reconstruction device 4 and optionally a second 2D camera 305 of the 3D reconstruction device 4.

The data provided by these data sources or sensors are stored in a synchronized manner in a storage unit 7 of the mobile capture apparatus (step 306). That means that
the first position indication of the position in the global reference system and/or raw data assigned to this position indication; and
the one or more second position indications; and
the one or more second orientation indications; and
the captured image data and/or the captured depth data and/or the captured linear accelerations of the mobile capture apparatus 1 in three mutually orthogonal axes of the local reference system and also the angular velocities of the rotation of the mobile capture apparatus 1 about these axes;
   are stored in a temporally synchronized manner in the storage unit 7 of the capture apparatus 1.

By means of the LIDAR measuring device 303, the depth data of the scene are captured and one of the second position indications and one of the orientation indications are determined by means of visual odometry on the basis of the depth data. On the basis of the image data and/or depth data determined by the LIDAR measuring device 303, a local 3D point cloud having a plurality of points is generated, cf. block 307.

By means of the first 2D camera 304 and optionally the second 2D camera 305, the image data and/or the depth data of the scene 350 are captured and one of the second position indications and one of the orientation indications are in each case determined by means of visual odometry on the basis of the respective image data and/or the depth data of the 2D camera 304 and optionally 305. For this purpose, feature points are extracted, cf. block 308 and optionally 309.

Furthermore, on the basis of image data and/or depth data captured by the 3D reconstruction device 4, at least one infrastructure element, in particular a line or a connection element, is detected and classified and optionally segmented, cf. block 310. In this case, one or more of the following items of information are obtained: color of an infrastructure element, diameter of an infrastructure element, course of an infrastructure element, bending radius of an infrastructure element, first and second position indications of the mobile capture apparatus. The detection, classification and optionally segmentation can be effected by means of an artificial neural network configured as part of a data processing device of the mobile capture apparatus, in particular as software and/or hardware.

The mobile capture apparatus can optionally comprise a device for voice control. Auditory information used for detecting and classifying the infrastructure elements and/or for allocating the georeference to the points of the 3D cloud can be captured via the device for voice control.

The output data present as local 2D data of blocks 307, 308, 309 and 310 are firstly transformed into 3D data (block 311), in particular by back projection.

The data of a plurality of frames 350, 351, 352 of a scene that have been transformed in this way are then fed to sensor data fusion 312, which carries out an estimation of the position and of the orientation of the mobile capture apparatus 1 on the basis of a nonlinear equation system. A factor graph is preferably used for the purpose of sensor data fusion 312, which factor graph represents the complex relationships between different variables and factors. In this context, the motion information (angular velocities, orientation indications, etc.) added sequentially for each frame can be fused with carrier phase observations (GNSS factors) in a bundle adjustment. In this case, the GNSS factors represent direct observations of the georeferenced position of a frame, whereas the relative pose factors yield information about the changes in pose between the frames and feature point factors link the local location references (e.g. recognizable structures and/or objects) detected in the image recordings and establish the spatial reference to the surroundings. Furthermore, the results of the detection, classification and/or segmentation of infrastructure elements (color information, geometric application-specific features such as e.g. diameter, course, bending radii, first and second position indications of the mobile capture apparatus, etc.) can concomitantly influence the sensor data fusion mentioned above. What arises as the result of the sensor data fusion 312 is a continuous, globally fully, newly aligned 3D point cloud of all entire frames of a scene, on the basis of which all infrastructure elements can be extracted three-dimensionally, in a georeferenced manner with an absolute accuracy of a few centimeters.

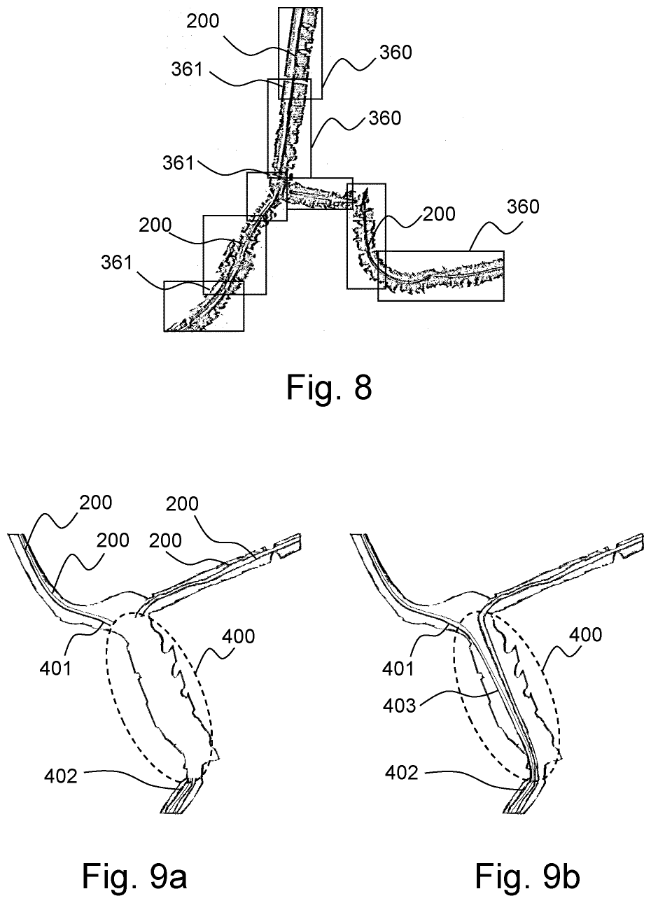

The illustration in FIG. 8 shows a plan view of a portion of a distribution network with a plurality of infrastructure elements 200 that were captured by means of the method according to the invention and the apparatus according to the invention. In this case, regions that were captured as part of a common scene, i.e. as part of a continuous sequence of a plurality of frames, are marked by a small box 360. The scenes are recorded in temporal succession, for example whenever the respective section of the distribution network is exposed. As a result of overlap, some overlap regions 361 are contained in two different scenes and thus doubly. The temporal sequence of the scenes may extend over a number of days. These scenes are combined in the context of the sensor data fusion, with the result that a single, common 3D point cloud of the distribution network is generated which contains no doubly recorded regions. In this case, it is advantageous if with the aid of the sensor data fusion regions of infrastructure elements recorded multiply or at different times, such as overlaps between two recordings, for example, are recognized and reduced to the temporally most recent captured regions of the infrastructure elements.

FIG. 9a shows a plan view of a part of a distribution network which was laid partly in a closed manner of construction, e.g. by means of press drilling. During the capture of this part of the distribution network, a part of the infrastructure elements 200 arranged underground is not optically capturable by the mobile capture apparatus 1 on account of concealment, cf. concealed region 400. A total of four such partly concealed infrastructure elements are illustrated in FIG. 9a. An optical vacancy thus arises in the 3D point cloud or the network defined by the 3D objects. In accordance with one configuration of the present invention, the optical vacancy between two 3D objects 401, 402 corresponding to a first infrastructure element 200 is recognized, and a connection 3D object 403, in particular as a 3D spline, is generated for closing the optical vacancy, cf. FIG. 9b. For recognizing the optical vacancy, one or more features of a first end of a first 3D object 401 and the same feature(s) of a second end of a second 3D object 402 are determined. The features of the two ends are compared with one another. The features can be for example the diameter and/or the color and/or the orientation and/or position indications. Alternatively, provision can be made for the user of the mobile capture apparatus to put the latter into an optical vacancy mode, for example by activating an operator control element of the mobile capture apparatus. In the optical vacancy mode, the operator can move the mobile capture apparatus above the concealed infrastructure element proceeding from an end of the infrastructure element corresponding to the first end of the first 3D object 401 along an optical vacancy trajectory as far as the end of the infrastructure element 200 corresponding to the second end of the second 3D object 402. The mobile capture apparatus 1 can then generate a connection 3D object 403 connecting the first end of the first 3D object 401 to the second end of the second 3D object 402, said connection 3D object being illustrated in FIG. 9b.

### REFERENCE SIGNS

1 Mobile capture apparatus
2 One or more receivers
3 Inertial measurement unit
4 3D reconstruction device
5 Laser pointer
6 Data processing device
7 Storage unit
8 Display device
9 Housing
10 Communication device
100 Method
101 Data capturing step
102 Reconstruction step
103 Georeferencing step
104 Recognition step
105 Data conditioning step
106 Visualization step
200, 200′, 200″ Infrastructure element
201 Person
302 Mobile radio interface
303 LIDAR measuring device
304 2D camera
305 2D camera
306 Synchronization
307 Generation of local 3D point cloud
308 Extraction of feature points
309 Extraction of feature points
310 Detection and classification
311 Back projection
312 Sensor data fusion
350, 351, 352 Frame
360 Scene
361 Overlap region
400 Optically concealed region
401, 402 3D object
403 Connection 3D object

1. A method for the positionally correct capture of exposed infrastructure elements having a diameter less than 30 cm and which are arranged in an open excavation, by means of a mobile capture apparatus, wherein:
by means of a 3D reconstruction device of the mobile capture apparatus, capturing image data and depth data of a scene containing at least one exposed infrastructure element arranged underground, and generating a 3D point cloud having a plurality of points on a basis of the image data and the depth data;
by means of one or more receivers of the mobile capture apparatus, receiving signals of one or more global navigation satellite systems, and determining a first position indication of a position of the mobile capture apparatus in a global reference system; and
c) determining a plurality of second position indications of the position of the mobile capture apparatus in a local reference system and a plurality of orientation indications of the orientation of the mobile capture apparatus in the respective local reference system,
i) wherein the determining one of the plurality of second position indications and one of the plurality of orientation indications is effected by means of an inertial measurement unit of the mobile capture apparatus, which captures linear accelerations of the mobile capture apparatus in three mutually orthogonal principal axes of the local reference system and angular velocities of a rotation of the mobile capture apparatus about the three mutually orthogonal principal axes, and
ii) wherein the 3D reconstruction device comprises more than one 2D camera, by means of which the image data and the depth data of the scene are captured and the determination of the one of the plurality of second position indications and of the one of the plurality of orientation indications is effected by means of visual odometry on the basis of the image data and the depth data; and
iii) wherein the mobile 3D reconstruction device comprises a LIDAR measuring device, by means of which the depth data of the scene are captured and the determination of the one of the plurality of second position indications and of the one of the plurality of orientation indications is effected by means of the visual odometry on the basis of the depth data;
d) allocating a respective georeference to the points of the 3D point cloud on the basis of the first position indication and a plurality of the second position indications and also a plurality of the orientation indications,
e) wherein the mobile capture apparatus is configured to be carried by a person and held by one or both hands of the person, the mobile capture apparatus has a housing having a largest edge length which is less than 50 cm, and wherein the one or more receivers, the inertial measurement unit, and the 3D reconstruction device are arranged in the housing.

2. (canceled)

3. (canceled)

4. (canceled)

5. The method as claimed in claim 1, wherein the image data and the depth data of a plurality of frames of the scene are captured and the 3D point cloud is generated.

6. The method as claimed in claim 1, wherein the one or more receivers are configured to receive reference or correction signals, from land-based reference stations.

7. The method as claimed in claim 1, wherein a LIDAR measuring device of the 3D reconstruction device is configured as solid-state LIDAR.

8. (canceled)

9. (canceled)

10. The method as claimed in claim 1, wherein the following are stored in a temporally synchronized manner in a storage unit of the mobile the capture apparatus:
a) the first position indication of the position in the global reference system and/or raw data assigned to the first position indication; and
b) the one or more second position indications; and
c) the one or more second orientation indications; and
d) the captured image data and/or the captured depth data and/or the captured linear accelerations of the mobile capture apparatus in the three mutually orthogonal axes of the local reference system and also the angular velocities of the rotation of the mobile capture apparatus about the three mutually orthogonal axes.

11. (canceled)

12. The method as claimed in claim 1, wherein allocating the respective georeference to the points of the 3D point cloud is effected by means of sensor data fusion, wherein a factor graph as a graphical model is applied for optimization purposes, wherein the sensor data fusion is based on a nonlinear equation system, on a basis of which an estimation of the position and of the orientation of the mobile capture apparatus is effected, and
wherein on the basis of the image data and/or depth data captured by the 3D reconstruction device, at least one infrastructure element or a line or a connection element, is detected and classified and the estimation of the position and of the orientation of the mobile capture apparatus on the basis of the nonlinear equation system is additionally effected on the basis of the results of the detection and classification of the infrastructure element.

13. (canceled)

14. (canceled)

15. The method as claimed in claim 1, wherein by means of the one or more receivers, signals from a maximum of three navigation satellites of a global navigation satellite system are received, wherein the respective georeference is allocated to the points of the 3D point cloud with an accuracy in a range of less than 10 cm, less than 5 cm, or less than 3 cm.

16. The method as claimed in claim 1, wherein the second position indications of the position of the mobile capture apparatus and/or the orientation indications of the mobile capture apparatus as prior information assist a resolution of ambiguities of differential measurements of carrier phases in order to georeference infrastructure elements even if the one or more receivers report a failure or determine a usable second position indication and/or orientation indication only for a short time by means of the inertial measurement unit.

17. The method as claimed in claim 12, wherein with an aid of the sensor data fusion regions of infrastructure elements recorded multiply or at different times are recognized and reduced to a temporally most recent captured region of the infrastructure elements.

18. (canceled)

19. The method as claimed in claim 1, wherein a plausibility of a temporal sequence of first position indications of the position of the capture apparatus in the global reference system is determined by a first velocity indication being determined on the basis of the temporal sequence of first position indications and a second velocity indication being calculated on the basis of the captured linear accelerations and angular velocities and being compared with the first velocity indication.

20. The method as claimed in claim 1, wherein on the basis of the 3D point cloud and/or on the basis of the image data, at least one infrastructure element is detected and classified, and
wherein at least one histogram of color and/or grayscale value information, and/or saturation value information and/or brightness value information and/or of an electromagnetic wave spectrum of a plurality of points of the 3D point cloud is generated for the detection, classification and/or segmentation.

21. (canceled)

22. (canceled)

23. The method as claimed in claim 20, wherein the histogram or histograms local maxima are detected and among the local maxima such maxima with the smallest separations with respect to a predefined color, saturation and brightness threshold value of an infrastructure element are detected.

24. The method as claimed in claim 23, wherein a group of points whose points do not exceed a predefined separation threshold value with respect to the color information composed of the detected local maxima is extended iteratively by further points which do not exceed a defined geometric and color separation with respect to those of the group, in order to form a locally continuous region of an infrastructure element with similar color information.

25. (canceled)

26. The method as claimed in claim 20, wherein for the detection, classification and/or segmentation of the infrastructure elements, color or grayscale value information of the captured image data and/or the captured depth data and associated label information are fed to an artificial neural network for training purposes.

27. The method as claimed in claim 1, wherein for each detected infrastructure element, an associated 3D object is generated on the basis of the 3D point cloud.

28. The method as claimed in claim 1, wherein an optical vacancy between two 3D objects is recognized and a connection 3D object as a 3D spline, is generated for closing the optical vacancy.

29. The method as claimed in claim 28, wherein in that for recognizing the optical vacancy, a feature of a first end of a first 3D object and the same feature of a second end of a second 3D object are determined, wherein the first and second features are compared with one another and the first and second features are a diameter or a color or an orientation or a georeference.

30. The method as claimed in claim 28, wherein the mobile capture apparatus is put into an optical vacancy mode and is moved proceeding from the first end to the second end.

31. (canceled)

32. (canceled)

33. (canceled)

34. The method as claimed in claim 1, wherein by means of a display device of the mobile capture apparatus, one or more of the following are displayed:
i) a representation of the 3D point cloud;
ii) a textured mesh model generated on the basis of the 3D point cloud and the image data of the more than one 2D camera;
iii) 3D objects corresponding to infrastructure elements;
iv) a 2D location plan;
v) a parts list of infrastructure elements;
vi) a superposition of image data of a 2D camera of the capture apparatus with a projection of one or more 3D objects corresponding to an infrastructure element;
vii) a superposition of image data of a 2D camera of the capture apparatus with a projection of a plurality of points of the 3D point cloud.

35. A mobile capture apparatus for the positionally correct capture of exposed infrastructure elements having a diameter less than 30 cm and which are arranged underground in an open excavation, comprising:
a 3D reconstruction device for capturing image data and depth data of a scene containing at least one exposed infrastructure element arranged underground, and for generating a 3D point cloud having a plurality of points on the basis of the image data and the depth data;
one or more receivers for receiving signals of one or more global navigation satellite systems and for determining a first position indication of the position of the capture apparatus in a global reference system;
an inertial measurement unit for determining a second position indication of the position of the capture apparatus in a local reference system and an orientation indication of the orientation of the capture apparatus in the local reference system, wherein the inertial measurement unit is designed to capture linear accelerations of the mobile capture apparatus in three mutually orthogonal principal axes of the local reference system and angular velocities of the rotation of the mobile capture apparatus about the three mutually orthogonal principal axes;
and
wherein the 3D reconstruction device comprises more than one 2D camera, by means of which the image data and the depth data of the scene are capturable, wherein a second position indication of the position of the capture apparatus in the local reference system and the orientation indication are determinable by means of visual odometry on the basis of the image data and the depth data;
wherein the 3D reconstruction device comprises a LIDAR measuring device, by means of which depth data of the scene are capturable, wherein a second position indication of the position of the capture apparatus in the local reference system and the orientation indication are effected by means of visual odometry on the basis of the depth data;
wherein the capture apparatus is configured to allocate a respective georeference to the points of the 3D point cloud, on the basis of the first position indication and a plurality of the second position indications and also a plurality of the orientation indications;
wherein the mobile capture apparatus is able to be carried by a person, wherein the mobile capture apparatus is able to be held by both hands of a person, preferably by one hand of a person, and has a housing, the largest edge length of which is less than 50 cm, wherein the receiver(s), the inertial measurement unit and the 3D reconstruction device are arranged in the housing.

36. (canceled)

37. (canceled)

38. (canceled)

39. (canceled)

40. (canceled)

41. (canceled)

42. (canceled)

43. (canceled)

44. (canceled)
